(19) United States
(12) Patent Application Publication
(10) Pub. No.: US 2020/0399907 A1
(43) Pub. Date: Dec. 24, 2020

(54) BRACKET SYSTEM AND METHOD FOR INSTALLATION OF HORIZONTAL BALUSTERS

(71) Applicant: Vinylast, Inc., Lakewood, NJ (US)

(72) Inventor: Steven J. Leary, Barnegat, NJ (US)

(21) Appl. No.: 16/445,527

(22) Filed: Jun. 19, 2019

(51) Int. Cl. E04F 11/18; F16B 7/18

(52) U.S. Cl. CPC E04F 11/1817; E04F 2011/1819; E04F 11/1834; F16B 7/18

(57) ABSTRACT

In one example, a baluster bracket for securing a baluster in a perpendicular orientation relative to a support surface includes a button bracket and a tube bracket. The button bracket includes a cylindrical body, wherein an outer surface of the cylindrical body is threaded, and a first aperture defined through the cylindrical body. The tube bracket includes a hollow cylindrical body, wherein an inner surface of the hollow cylindrical body is threaded to engage the outer surface of the cylindrical body of the button bracket.

### FIELD OF THE INVENTION

The present invention relates generally to railing systems and relates more specifically to support hardware for use in railing systems.

### BACKGROUND OF THE DISCLOSURE

Railing systems are frequently used in the construction of decks, porches, stairs, and other structures. Railing systems may be installed in a level orientation (e.g., as in the case of a fence) or in an angled orientation (e.g., as in the case of a stairway or ramp).

A typical segment of a railing installation comprises two vertically oriented support surfaces (e.g., posts and/or walls) with a plurality of balusters (or rails) mounted in between the support surfaces. The balusters may be oriented vertically (e.g., parallel with the support surfaces) or horizontally (e.g., perpendicular with the support surfaces).

### SUMMARY OF THE INVENTION

A novel bracket system and a method for using the bracket system to install horizontal balusters in a railing system are disclosed. In one example, a baluster bracket for securing a baluster in a perpendicular orientation relative to a support surface includes a button bracket and a tube bracket. The button bracket includes a cylindrical body, wherein an outer surface of the cylindrical body is threaded, and a first aperture defined through the cylindrical body. The tube bracket includes a hollow cylindrical body, wherein an inner surface of the hollow cylindrical body is threaded to engage the outer surface of the cylindrical body of the button bracket.

In another example, a baluster bracket for securing a baluster in an angled orientation relative to a support surface includes a button bracket, and adjustable angle bracket, and a tube bracket. The button bracket includes a cylindrical body, wherein an outer surface of the cylindrical body is threaded, and a first aperture defined through the cylindrical body. The adjustable angle bracket includes a first segment including a threaded portion and a seat portion, wherein threads of the threaded portion are designed to engage the outer surface of the cylindrical body of the button bracket, and a second segment positioned within the seat portion and secured to the first segment via a hinge, wherein an interior surface of the second segment is threaded. The tube bracket includes a hollow cylindrical body, wherein an inner surface of the hollow cylindrical body is threaded to engage the threaded portion of the first segment of the adjustable angle bracket.

In another example, a method for securing a baluster to a support surface includes installing a button bracket in a through-hole in the support surface. The button bracket includes a cylindrical body, wherein an outer surface of the cylindrical body is threaded, and a first aperture defined through the cylindrical body, wherein the installing comprises inserting a screw through the aperture and the through-hole to secure the button bracket flush against the support surface. An end of the baluster is then fitted within a first end of a tube bracket. The tube bracket includes a hollow cylindrical body, wherein an inner surface of the hollow cylindrical body is threaded. A second end of the tube bracket is slid over the button bracket. The tube bracket is then turned so that threads on the inner surface of the hollow cylindrical body engage the outer surface of the cylindrical body, until the tube bracket is secured flush against the support surface.

### BRIEF DESCRIPTION OF THE DRAWINGS

The teachings of the present disclosure can be readily understood by considering the following detailed description in conjunction with the accompanying drawings, in which:

FIG. 1, for instance, illustrates a portion of an example railing system in which the balusters are installed in a horizontal orientation, according to the present disclosure;

FIGS. 2A-2B illustrate the components of the baluster bracket of FIG. 1, according to one example of the present disclosure;

FIG. 3 is a flow diagram illustrating one example of a method for installing a railing system including horizontal balusters, according to the present disclosure;

FIG. 4A illustrates the installation of the button bracket illustrated in FIG. 2A in an example post;

FIG. 4B illustrates the installation of the tube bracket 202 illustrated in FIG. 2B in the example post 102 of FIG. 4A;

FIG. 4C illustrates the finished installation of two baluster brackets (including button brackets and tube brackets) on opposite ends of an example baluster;

FIG. 5A illustrates a side view of one example of an adjustable angle bracket, according to the present disclosure;

FIG. 5B illustrates a view of the adjustable angle bracket of FIG. 5 in which the adjustable angle bracket is rotated counter-clockwise by ninety degrees about the axis A-A′; and

FIG. 5C illustrates the installation of the adjustable angle bracket of FIGS. 5A-5B, e.g., according to the method illustrated in FIG. 3.

To facilitate understanding, identical reference numerals have been used, where possible, to designate identical elements that are common to the figures.

### DETAILED DESCRIPTION

The present disclosure describes a novel bracket system and a method for using the bracket system to install horizontal balusters in a railing system. As discussed above, the balusters of a railing system may be oriented vertically (e.g., parallel with the support surfaces) or horizontally (e.g., perpendicular with the support surfaces).

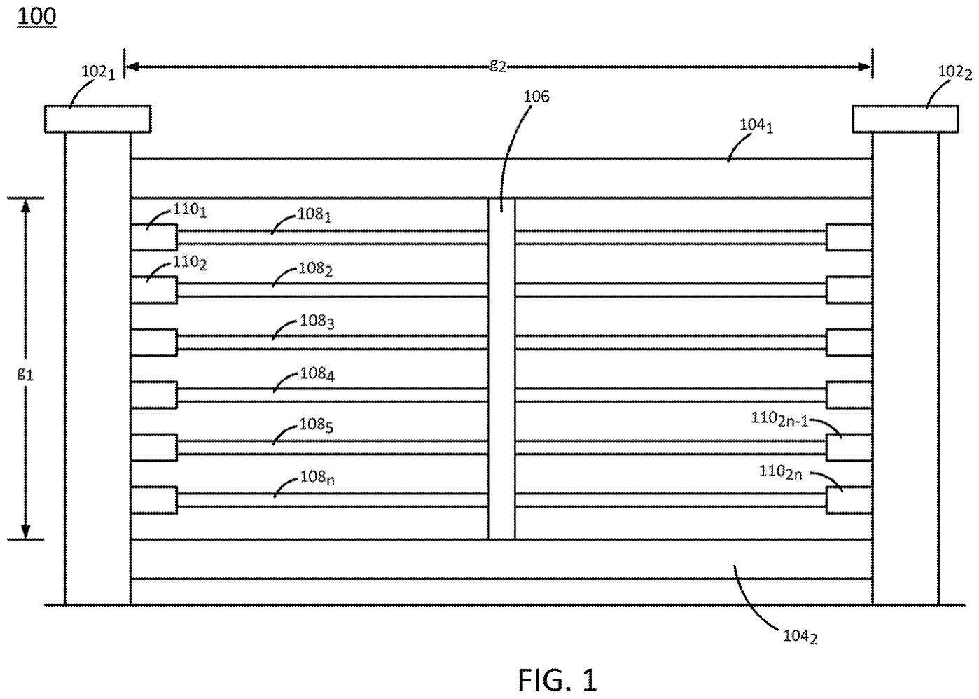

FIG. 1, for instance, illustrates a portion of an example railing system 100 in which the balusters are installed in a horizontal orientation, according to the present disclosure. As illustrated, the railing system includes two support surfaces, which in the example of FIG. 1 comprise posts 102₁ and 102₂ (hereinafter individually referred to as a “post 102” or collectively referred to as “posts 102”). In other examples, one or more of the posts 102 may be replaced with another vertically oriented (or upright) support surface, such as a wall. A top railing 104₁ and a bottom railing 104₂ (hereinafter individually referred to as a “railing 104” or collectively referred to as “railings 104”) are installed between the posts 102 in a spaced apart manner, i.e., leaving a first gap₁ between the railings 104 that may be several inches to several feet wide (e.g., up to forty-two inches in one example). As illustrated, the railings 104 are installed in a horizontal orientation, i.e., the longest dimension of the railings 104 is oriented perpendicular to the longest dimension of the posts 102.

In one example, if a second gap between the posts 102 is greater than a threshold (e.g., forty-eight inches in one example), the railing system 100 may additionally include an intermediate blade baluster 106 installed midway between the posts 102 (e.g., at a distance of g₂/2 from each of the posts 102) to provide additional structural support to the top railing 104₁. As illustrated, the intermediate blade baluster 106 is oriented in a vertical or upright position, i.e., the longest dimension of the intermediate blade baluster 106 is oriented parallel to the longest dimension of the posts 102. The intermediate blade baluster 106 may include a plurality of apertures (not shown) formed along its longest dimension in order to allow the horizontal balusters (discussed below) to pass through.

The railing system 100 further includes a plurality of horizontal balusters 108₁-108ₙ (hereinafter individually referred to as a “baluster 108” or collectively referred to as “balusters 108”) installed between the posts 102. As illustrated, the balusters 108 are oriented in a horizontal position, i.e., the longest dimension of the balusters 108 is oriented perpendicular to the longest dimension of the posts 102 (or parallel to the longest dimension of the railings 104). In particular, the balusters 108 are installed in a spaced apart relation (relative to each other) within the first gap₁.

In one example, each end of each baluster 108 is secured to one of the posts 102 using a baluster bracket 110₁-110₂ₙ (hereinafter individually referred to as a “baluster bracket 110” or collectively referred to as “baluster brackets 110”). For ease of illustration, only four of the baluster brackets 104 in FIG. 1 are labeled.

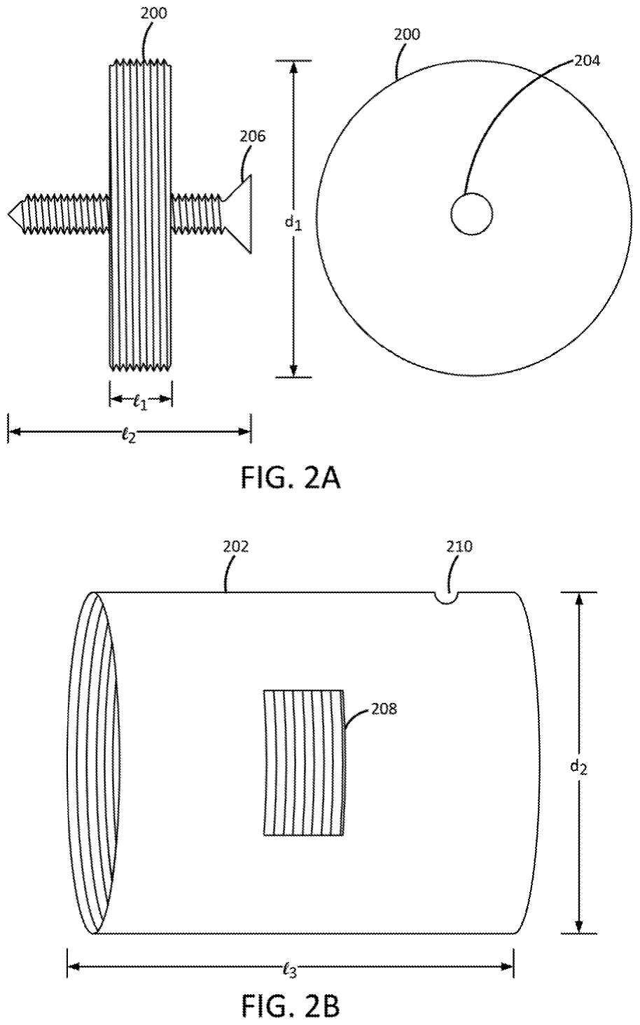

FIGS. 2A-2B illustrate the components of the baluster bracket 110 of FIG. 1, according to one example of the present disclosure. In particular, FIG. 2A illustrates a button bracket 200 portion of the baluster bracket 110, while FIG. 2B illustrates a tube bracket 202 portion of the baluster bracket 110. Each of the button bracket 200 and the tube bracket 205 may be formed from plastic, metal, rubber, or other materials.

As shown in FIG. 2A, the button bracket 200 comprises a substantially cylindrical body. The cylindrical body may be hollow or solid and may have a circular cross section. An aperture 204 may be defined through the center of the body of the button bracket 200, e.g., at the midpoint of the button bracket's diameter d₁. In one example, the aperture 204 is sized to accept a screw 206. In one example, the length [symbol] ₁ of the button bracket is shorter than the length [symbol] ₂ of the screw. The perimeter or outer surface of the button bracket 200 is threaded along its length [symbol] ₁.

As shown in FIG. 2B, the tube bracket 202 comprises a substantially hollow, cylindrical body. The inner diameter d₂ of the tube bracket 202 may be slightly larger than the outer diameter d₁ of the button bracket 200. The inner diameter d₂ of the tube bracket 202 may also be slightly larger than the outer diameter of a baluster to be secured by the baluster bracket 110, as discussed in greater detail below. The length [symbol] ₃ of the tube bracket 202 may be greater than the length [symbol] ₁ of the button bracket 200. The inner surface of the tube bracket 202 may be threaded to engage the threads on the outer surface of the button bracket 200, as described in further detail below.

A first aperture 208 is defined in the perimeter or outer surface of the tube bracket 202. In one example, the first aperture 208 is substantially rectangular in shape, though other shapes may be possible. The first aperture 208 may be located near a midpoint along a longest dimension of the tube bracket 202. In addition, a second aperture 210 is also defined in the perimeter or outer surface of the tube bracket 202. In one example, the second aperture 210 is sized and shaped to accept the end of an Allen wrench (e.g., the second aperture 210 may be hexagonal in shape). The second aperture 210 may be located near one end of the tube bracket 202.

FIGS. 2A-2B illustrate only one example of a button bracket 200 and tube bracket 202 that may form a horizontal baluster bracket 110. In other examples, the button bracket 200 and/or tube bracket 202 may be configured in a manner other than that which is illustrated. For instance, rather than being threaded, the perimeter or outer surface of the button bracket 202 may comprise a series of rubber or plastic teeth, while the inner surface of the tube bracket 202 may be smooth instead of threaded. This would allow the outer surface of the button bracket 202 to engage the inner surface of the tube bracket 202 via an interference fit.

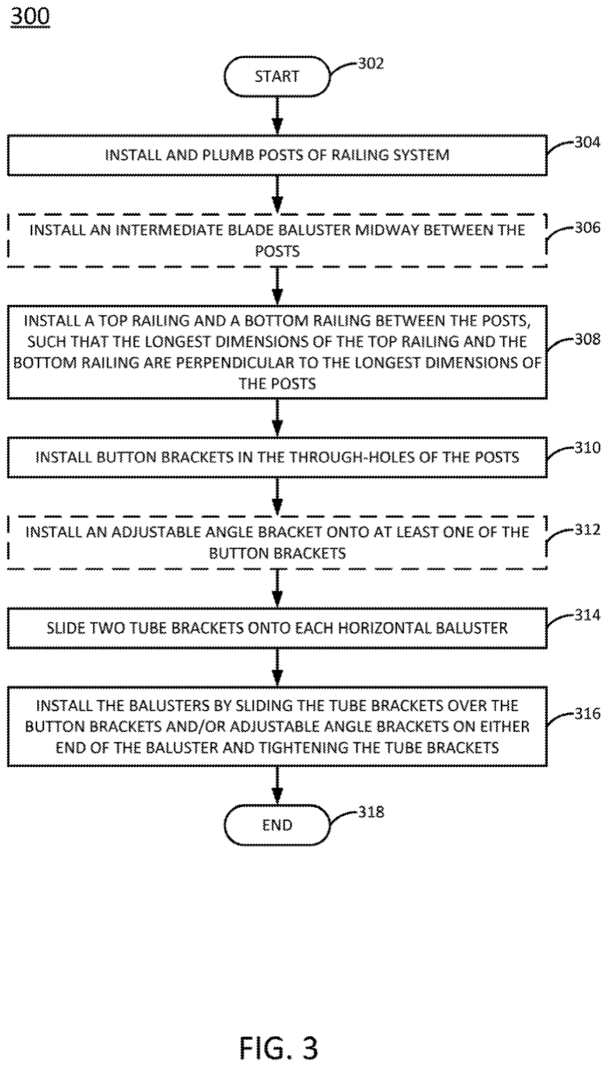

FIG. 3 is a flow diagram illustrating one example of a method 300 for installing a railing system including horizontal balusters, according to the present disclosure. For example, the method 300 may be used to install at least a portion of the railing system 100 illustrated in FIG. 1. The method 300 assumes that the railings system is being installed between two posts (e.g., as illustrated in FIG. 1); however, one or both of the posts could be replaced with a rail or other vertical or upright support surface without departing from the scope of the present disclosure.

The method 300 may begin in step 302. In step 304, the posts may be installed and plumbed. That is, the posts are secured to a surface (e.g., the floor of a deck, a patio, or the like) and are adjusted, if necessary, so that they are level with the surface. In one example, the posts are spaced apart by a gap as discussed above. In one example, the posts may be pre-drilled (i.e., prior to installation) to include a plurality of through-holes for securing the horizontal balusters (discussed in further detail below). Thus, the through-holes are spaced apart from each other, along the longest dimension of the posts, according to the desired spacing of the horizontal balusters. In another example, the through-holes may be drilled into the posts after the posts have been installed and plumbed. A drill template or an intermediate blade baluster (discussed in further detail below) may be used to locate each of the through-holes and to ensure proper spacing.

In step 306, the top railing (and optionally the bottom railing) may be installed between the posts. As discussed above, the railings are installed in a horizontal orientation, i.e., the longest dimension of the railings is oriented perpendicular to the longest dimension of the posts. When a bottom railing is used, the top railing is spaced apart from the bottom railing by a gap₁ that may be several inches to several feet wide (e.g., up to forty-two inches in one example). In one example, the bottom railing may be secured directly to the flooring.

In optional step 308 (illustrated in phantom), an intermediate blade baluster may be installed midway between the posts (e.g., at a distance of g₂/2 from each of the posts). In one example, the intermediate blade baluster is installed when the gap is greater than forty-eight inches to provide additional structural support to the top railing (discussed in further detail below). However, the intermediate blade baluster may also be installed when the gap is less than forty-eight inches. The intermediate blade baluster is oriented in a vertical or upright position, i.e., the longest dimension of the intermediate blade baluster is oriented parallel to the longest dimension of the posts. The intermediate blade baluster may include a plurality of apertures formed along its longest dimension in order to allow the horizontal balusters (discussed in further detail below) to pass through. These apertures may be lined up with the through-holes in the posts.

It should be noted that when an intermediate blade baluster is used, steps 306 and 308 may be performed together. For instance, the bottom railing may be installed, and the intermediate blade baluster may subsequently be secured to the bottom railing (e.g., using a first swivel bracket or similar fastener). Next, the top railing may be secured to the intermediate blade baluster (e.g., using a second swivel bracket or similar fastener).

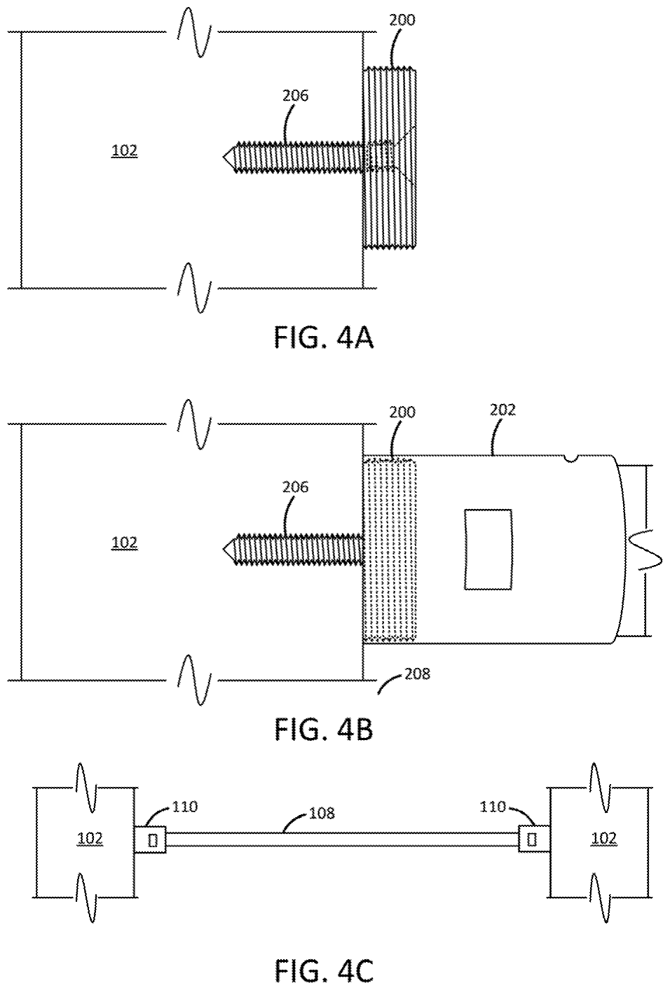

In step 310, button brackets may be installed in each of the through-holes in the posts. FIG. 4A illustrates the installation of the button bracket 200 illustrated in FIG. 2A in an example post 102. As shown, installation of the button bracket 200 may involve inserting a screw 206 through the aperture 204 of the button bracket and securing the screw in the through-hole of the post 102. This results in the button bracket 200 being secured flush against the outside of the post 102.

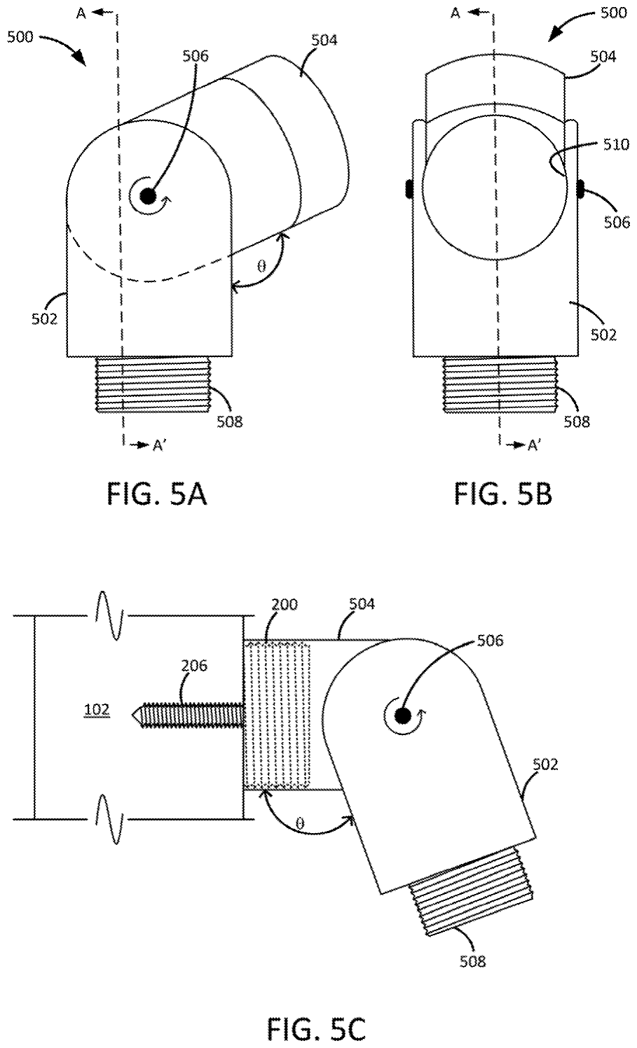

In optional step 312 (illustrated in phantom), an adjustable angle bracket may be installed onto at least one of the button brackets. FIG. 5A illustrates a side view of one example of an adjustable angle bracket 500, according to the present disclosure, while FIG. 5B illustrates a view of the adjustable angle bracket 500 of FIG. 5 in which the adjustable angle bracket 500 is rotated counter-clockwise by ninety degrees about the axis A-A′. An adjustable angle bracket 500 may be used when a baluster is to be installed at an angle that is not perpendicular to the support surface (e.g., not parallel to the ground). For instance, the baluster may be part of a stair railing system.

Referring simultaneously to FIGS. 5A and 5B, in one example, the adjustable angle bracket 500 may include a first segment 502 and a second segment 504 that are joined at a hinge 506. Both the first segment 500 and the second segment 502 may take approximately the shape of an elongated dome (e.g., a cylinder having a circular cross section, one flat end, and one rounded end).

In one example, the first segment 502 additionally includes a threaded portion 508 and a seat portion 510. The threaded portion 508 is located at one end of the first segment 502 (e.g., the flat end of the cylinder) and may have a circular cross section that is substantially concentric with the cross section of the first segment 502 (but has a smaller diameter than the cross section of the first segment 502).

In one example, the second segment 504 is hollow and open at one end (e.g., the flat end of the cylinder). In this case, the interior surface of the second segment 504 may be threaded.

As illustrated, the second segment 504 fits within the seat portion 510 of the first segment 502, and the hinge 506 passes through both the first segment 502 and the second segment 504. In this way, either of the first segment 502 and the second segment 504 may rotate relative to each other around the hinge to adjust an angle θ formed between the first segment 502 and the second segment 504. In one example, the hinge may be tightened to set the angle θ (e.g., to prevent further relative rotation of the first segment 502 and the second segment 504).

FIG. 5C illustrates the installation of the adjustable angle bracket 500 of FIGS. 5A-5B, e.g., according to step 312 of the method 300 illustrated in FIG. 3. As illustrated, installation of the adjustable angle bracket 500 may involve sliding the second segment 504 of the adjustable angle bracket 500 over an installed button bracket 200. The adjustable angle bracket 500 may be tightened by turning the adjustable angle bracket 500 so that the threads on the interior surface of the second segment 504 engage the threads on the outer surface of the button bracket 200. The angle θ may then be adjusted as necessary by rotating the first segment 502 of the adjustable angle bracket 500 toward or away from the second segment 504.

Referring back to FIG. 3, in step 314, two tube brackets may be slid onto the outside of each baluster. In this case, the inner diameter of the tube brackets is slightly larger than the outer diameter of the balusters, such that the tube brackets may slide freely over the outside of the balusters.

In step 316, each of the balusters is installed. In one example (e.g., where a baluster is being installed in an orientation that is perpendicular to the posts 102, or parallel to the ground), the baluster is installed by sliding the baluster's tube brackets (e.g., one tube bracket on each end of the baluster) over respective button brackets. FIG. 4B illustrates the installation of the tube bracket 202 illustrated in FIG. 2B in the example post 102 of FIG. 4A. As shown, installation of the tube bracket 202 may involve sliding the tube bracket over a respective button bracket 200. In one example, both tube brackets 202 on a baluster are slid onto their respective button brackets (where the respective button brackets are located at the same height or same distance from the bottom railing, such that the baluster is held in a parallel orientation relative to the bottom railing), and then the tube brackets are subsequently tightened. FIG. 4C illustrates the finished installation of two baluster brackets 110 (including button brackets 200 and tube brackets 202) on opposite ends of an example baluster 108.

Tightening of the tube brackets 202 may involve turning the tube brackets 202 so that threads on the inner surface of the tube brackets engage the threads on the outer surface of the button brackets 200, pulling the tube brackets 202 flush against the posts 102. In one example, the tube brackets 202 may be turned by using an adjustable or open end wrench that grips the first aperture (208 of FIG. 2B) in the tube brackets 202. In another example, the tube brackets 202 may be turned by using an Allen wrench that is sized to engage the second aperture (210 of FIG. 2B) in the tube brackets 202.

In another example (e.g., where the balusters are longer than six feet), a first tube bracket 202 on a first end of the baluster may be installed completely (i.e., including tightening) on a first button bracket 200 before a second tube bracket 202 on a second end of the baluster is slid over a second button bracket. This may make it easier for the individual performing the installation to hold and install the second end of the baluster (e.g., as opposed to sliding the tube brackets over the button brackets 200 on both ends before tightening either tube bracket 202).

In another example (e.g., where a baluster is being installed in an orientation that is angled relative to the posts 102, or relative to the ground), the baluster is installed by sliding the baluster's tube brackets (e.g., one tube bracket on each end of the baluster) over the first segments 502 of respective adjustable angle brackets 500. More specifically, the tube brackets may be slid over the threaded portions 508 of the adjustable angle brackets 500 and turned, so that the threads on the inner surfaces of the tube brackets engage the threaded portions 508 of the adjustable angle brackets 500.

In either case, if an intermediate blade baluster is installed between the posts (e.g., according to step 304), the balusters may be passed through the apertures in the intermediate blade balusters during installation in step 314.

Once each baluster of the railing system is installed in accordance with steps 310-316, the method 300 may end in step 318.

It should be noted that in various embodiments, one or more of the above steps of the method 300 can be deemed as an optional step. Furthermore, operations, steps, or blocks of the above described method can be combined, separated, and/or performed in a different order from that described above, without departing from the example embodiments of the present disclosure.

The present disclosure therefore provides a baluster bracket that can be used to securely install a horizontal baluster in a railing system. The baluster bracket may be used alone to install the horizontal baluster in a level (e.g., perpendicular to the support surfaces, and parallel to the ground) orientation, such as might be desirable for fencing and safety railings. The baluster bracket may also be used in conjunction with an adjustable angle bracket to install the horizontal baluster in an angles (e.g., angled relative to the support surfaces, and to the ground) orientation, such as might be desirable for stair railings.

Moreover, the disclosed baluster bracket (and method of installation) effectively hides the hardware that secures the baluster to the support surface. Specifically, the tube bracket hides the parts that are mechanically fastened to the support surface (e.g., the button bracket and the screw) from view. This results in a more aesthetically pleasing look to the railing system, as many individuals may find the attachment hardware to be unsightly. In addition, the present of the tube bracket may make it more difficult to access the button bracket and screw. Thus, the tube bracket may also serve as a safety feature that prevents tampering with the balusters.

Although various embodiments which incorporate the teachings of the present disclosure have been shown and described in detail herein, those skilled in the art can readily devise many other varied embodiments that still incorporate these teachings. In addition, while various embodiments have been described above, it should be understood that they have been presented by way of example only, and not limitation. Thus, the breadth and scope of a claimed embodiment should not be limited by any of the above-described exemplary embodiments, but should be defined only in accordance with the following claims and their equivalents.

What is claimed is:

1. A baluster bracket for securing a baluster in a perpendicular orientation relative to a support surface, comprising:
a button bracket, comprising:
a cylindrical body, wherein an outer surface of the cylindrical body is threaded; and
a first aperture defined through the cylindrical body; and
a tube bracket, comprising:
a hollow cylindrical body, wherein an inner surface of the hollow cylindrical body is threaded to engage the outer surface of the cylindrical body of the button bracket.

2. The baluster bracket of claim 1, further comprising:
a screw sized to fit through the first aperture.

3. The baluster bracket of claim 2, wherein a length of the screw is greater than a length of the button bracket.

4. The baluster bracket of claim 1, wherein the first aperture is defined through a center of the cylindrical body.

5. The baluster bracket of claim 1, wherein the tube bracket further comprises:
a first aperture defined in an outer surface of the hollow cylindrical body.

6. The baluster bracket of claim 5, wherein the tube bracket further comprises:
a second aperture defined in the outer surface of the hollow cylindrical body, wherein the second aperture is sized and shaped to accept an end of an Allen wrench.

7. The baluster bracket of claim 1, wherein an inner diameter of the hollow cylindrical body of the tube bracket is greater than an outer diameter of the cylindrical body of the button bracket.

8. The baluster bracket of claim 1, wherein an inner diameter of the hollow cylindrical body of the tube bracket is greater than a diameter of the baluster.

9. A baluster bracket for securing a baluster in an angled orientation relative to a support surface, comprising:
a button bracket, comprising:
a cylindrical body, wherein an outer surface of the cylindrical body is threaded; and
a first aperture defined through the cylindrical body;
an adjustable angle bracket, comprising:
a first segment including a threaded portion and a seat portion, wherein threads of the threaded portion are designed to engage the outer surface of the cylindrical body of the button bracket; and
a second segment positioned within the seat portion and secured to the first segment via a hinge, wherein an interior surface of the second segment is threaded; and
a tube bracket, comprising:
a hollow cylindrical body, wherein an inner surface of the hollow cylindrical body is threaded to engage the threaded portion of the first segment of the adjustable angle bracket.

10. The baluster bracket of claim 9, further comprising:
a screw sized to fit through the first aperture.

11. The baluster bracket of claim 10, wherein a length of the screw is greater than a length of the button bracket.

12. The baluster bracket of claim 9, wherein the first aperture is defined through a center of the cylindrical body.

13. The baluster bracket of claim 9, wherein the tube bracket further comprises:
a first aperture defined in an outer surface of the hollow cylindrical body.

14. The baluster bracket of claim 13, wherein the tube bracket further comprises:
a second aperture defined in the outer surface of the hollow cylindrical body, wherein the second aperture is sized and shaped to accept an end of an Allen wrench.

15. The baluster bracket of claim 9, wherein an inner diameter of the hollow cylindrical body of the tube bracket is greater than an outer diameter of the cylindrical body of the button bracket.

16. The baluster bracket of claim 9, wherein an inner diameter of the hollow cylindrical body of the tube bracket is greater than a diameter of the baluster.

17. The baluster bracket of claim 9, wherein the first segment of the adjustable angle bracket and the second segment of the adjustable angle bracket are rotatable relative to each other about the hinge, such that an angle defined between the first segment and the second segment is adjustable.

18. A method for securing a baluster to a support surface, comprising:
installing a button bracket in a through-hole in the support surface, wherein the button bracket comprises:
a cylindrical body, wherein an outer surface of the cylindrical body is threaded; and
a first aperture defined through the cylindrical body, wherein the installing comprises inserting a screw through the aperture and the through-hole to secure the button bracket flush against the support surface;
fitting an end of the baluster within a first end of a tube bracket, wherein the tube bracket comprises:
a hollow cylindrical body, wherein an inner surface of the hollow cylindrical body is threaded;
sliding a second end of the tube bracket over the button bracket; and
turning the tube bracket so that threads on the inner surface of the hollow cylindrical body engage the outer surface of the cylindrical body, until the tube bracket is secured flush against the support surface.

19. The method of claim 18, wherein the support surface is a post of a railing system.

20. The method of claim 19, wherein the installing, the fitting, the sliding, and the turning secures the baluster in an orientation that is perpendicular relative to the post.
